(19) United States
(12) Patent Application Publication
(10) Pub. No.: US 2015/0114198 A1
(43) Pub. Date: Apr. 30, 2015

(54) DEVICE FOR CUTTING PANELS

(71) Applicant: Giuseppe Gallucci, (US)

(72) Inventor: Giuseppe Gallucci, Monte Urano (Fermo) (IT)

(21) Appl. No.: 14/365,768

(22) PCT Filed: Dec. 18, 2012
(86) PCT No.: PCT/IB2012/057413

§ 371 Date: Jun. 16, 2014

(30) Foreign Application Priority Data
Dec. 20, 2011 (IT) BO2011A000737

(51) Int. Cl. B26D 7/08; B26F 1/38

(52) U.S. Cl. CPC B26D 7/086; B26F 1/382
USPC 83/613

(57) ABSTRACT

A device for cutting panels of a type constituted by two parallel films (21A, 21B) between which a reticular layer (22) is solidly interposed comprising an operating unit (4), mobile along axes X, Y, Z, which operating unit (4) rotatably supports a shaft (3) which is oscillating with respect to the axis β, with the lower end (3A) of the shaft being bent with respect to the oscillating axis β thereof; vibrating means (5) borne by the lower end (3A); a blade (2) keyed on the output spindle (5A) of the vibrating means (5).

### FIELD OF THE INVENTION

The present invention relates to the technical sector concerning obtaining spatially-developing articles (for example advertising display cases) obtained starting from a panel of a type constituted by a reticular structure, having a constant thickness, to which two films, parallel to one another, are solidly constrained on opposite sides.

Portions of predetermined area are fashioned from the panel, on each of which predetermined bend lines, i.e. lines about which the sides of the portion adjacent to the lines, can rotate.

This is obtained by cutting the portion of the panel such as to involve a film and the reticular structure by means of two cutting paths lying in inclined planes with respect to the films (for example at 45°).

In this way a bend line defined by the confluent line of the inclined planes is defined, situated at the uncut film, i.e. the film not involved in the cutting.

Following the cutting, the cut surfaces are brought together (possibly by means of application of glue thereon) by rotation of the relative sides with respect to the bend line: in this way an angular edge of the corresponding article is realized.

### DESCRIPTION OF THE PRIOR ART

At present the cuts referred-to above are obtained using fixed blades, i.e. blades subjected to a linear translational motion.

Complaints relating to this method comprise an accentuated wearing of the cutting edge of the blades, caused both by the excessive heating thereof and by the abrasive nature of the materials constituting the panel; the drawbacks deriving from this are obvious, such as for example non-optimal cuts (with chippings) and frequent replacements of the cutting means, with the consequent costs this involves.

US 2003/140762 discloses a device that uses a blade for cutting panels, or panels constituted by layered laminates, with the blade moved translatingly combined with a succession of oscillations.

### SUMMARY OF THE INVENTION

The advantage of the invention is that it obviates the drawbacks in the prior art, by means of a device for cutting the panels of the above-described type, which enables a movement of the blades such as to increase the average working life of the relative cutting edges and such as to realize the cutting of the panels without chipping.

These advantages were obtained according to the contents of the claims.

### BRIEF DESCRIPTION OF THE DRAWINGS

The characteristics of the invention are disclosed in the following with reference to the accompanying tables of the drawings, in which:

FIGS. 1-5 schematically illustrate, in plan view, the succession of operations by means of which starting from a portion of a panel an angular cut of a corresponding article is obtained;

FIGS. 6A, 6B are two views, perpendicular to one another, of the disclosed device.

### DESCRIPTION OF THE PREFERRED EMBODIMENTS

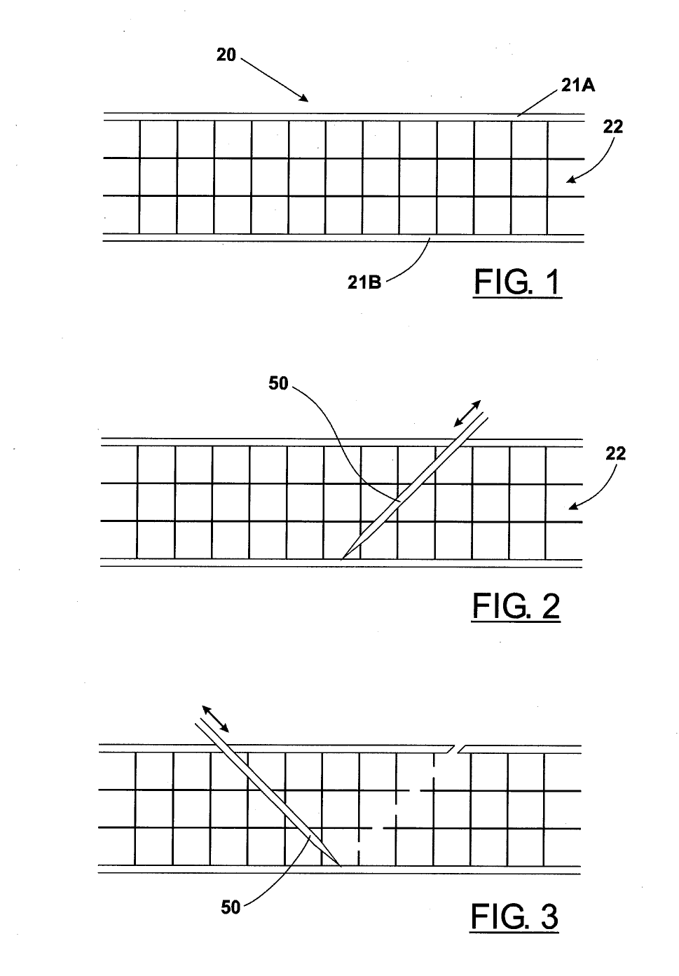

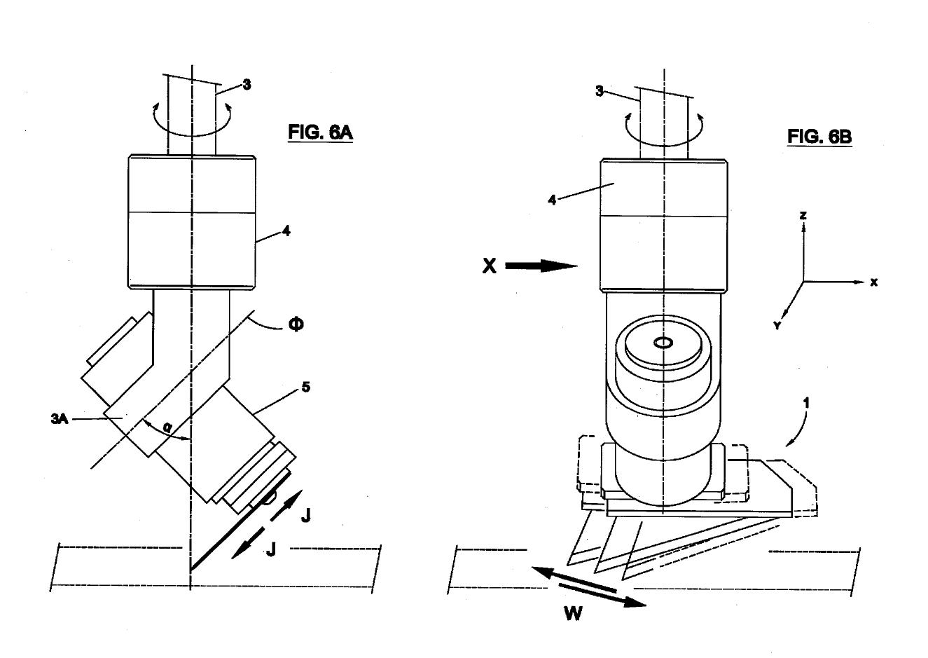

With reference to FIGS. 6A, 6B, 1 denotes a device bearing a cutting blade 2. The device is constituted by a shaft 3 rotatably supported by an operating unit 4 movable according to Cartesian axes X, Y, Z by means of known techniques in the sector.

The shaft 3 exits from both sides of the unit 4; the lower portion 3A of the shaft 3 is bent at an angle a with respect to the axis β thereof. The portion 3A supports vibrating means 5 of known type developing perpendicularly to the halfway line Φ of the portion 3A; a blade 2 is keyed on the output spindle 5a of the vibrating means 5.

X defines the translating direction of the device 1 and therefore the blade 2;

the vibrating means 5 impart vibrations on the blade (i.e. oscillations) or in direction X (directions W-W, FIG. 6B), or in the perpendicular direction to direction X (directions J-J, FIG. 6A).

Definitively, the cutting blade 2, apart from the translation motion (direction X), can be subjected to oscillations either in directions W-W or directions J-J; both the oscillations can coexist with the translation of the blade 2 in direction X.

With reference to FIG. 1, 20 denotes a panel constituted by two parallel films 21A, 21B between which a reticular layer 22 is solidly interposed.

The panel is cut with the device 1 according to the disclosed method after its positioning on a suitable flat support, not illustrated.

FIGS. 2-5 illustrate, purely by way of example, cuttings of the panel according to cutting planes 50, 60, inclined by 45° with respect to the films 21A, 21B.

For this purpose, by moving the operating unit 4 and if necessary, by intervening such as to rotate the shaft 3 (directions N₁, N₂) relative to the axis β, the blade 2 is positioned as in FIG. 6A.

At this point, the unit 4 is activated and the vibrating means 5 activated, such as to impart a translation on the blade 2 in direction X (FIG. 6B), with which the oscillations (vibrations) are combined in directions W-W, or in directions J-J, or in both the directions.

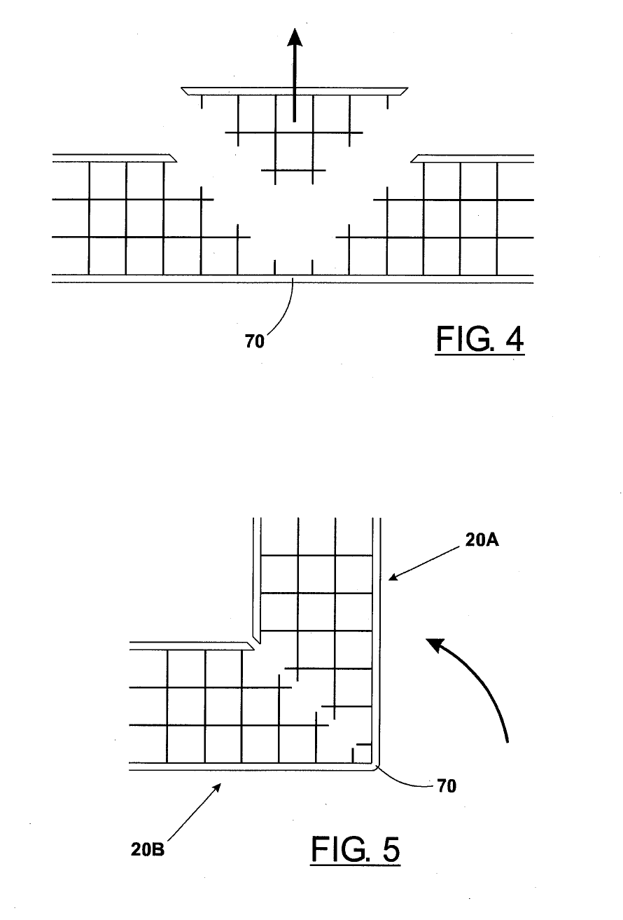

In the illustrated example the cutting of the panel only involves the film 21A and the reticular layer 22; the two cutting planes 50, 60 (FIG. 2, 3) identify, in the whole film 21B, a bend line 70 (FIG. 4).

The rotation of the sides of the panel 20A, 20B adjacent to the bend line 70 enable identifying a corner-piece of an article, which article is not illustrated in the drawings as it is not pertinent to the invention.

As specified above, FIGS. 2-5 illustrate an example of cutting of a panel; it is understood that the cutting can involve the whole panel, i.e. both the films 21A, 21B together with the layer 22.

It has been observed that the oscillations imparted on the blade 2 lead to a sort of self-cleaning effect on the cutting edge 2a of the blade; this prevents the chips (abrasive) of the cut panel from remaining on the blade, with a consequent increase in the duration thereof.

The above-mentioned oscillations lead, given a same operating velocity of the cutting of the panels in the prior art, to a decrease in the temperature of the cutting edge, which is translated into an increase in the duration of the blade. The positive effects mentioned above lead to an optimization of the quality of the cutting.

1. A device for cutting panels, the panels being of a type constituted by two parallel films between which a reticular layer is solidly interposed, comprising: an operating unit movable according to Cartesian axes X, Y and Z; a shaft rotatably supported by the operating unit, from which operating unit the shaft exits on both sides and oscillates with respect to an oscillation axis according to directions N₁-N₂, wherein a lower end of the shaft is bent with respect to the oscillation axis thereof; further comprising vibrating means borne by the lower end of the shaft, developing in an angled direction with respect to a half-way line of the lower end of the shaft; a blade keyed on an outlet spindle of the vibrating means, configured to cut at least a film and the adjacent reticular layer of the corresponding panel.

2. The device of claim 1, wherein the vibrating means develop perpendicularly with respect to the halfway line of the lower end.

3. The device of claim 1, wherein the vibrating means generate oscillations along a translation direction of the blade.

4. The device of claim 1, wherein the vibrating means generate oscillations perpendicular to a translation direction of the blade.

5. The device of claim 1, wherein the vibrating means generate oscillations both along a translation direction of the blade and perpendicular to the translation direction of the blade.

6. The device of claim 2, wherein the vibrating means generate oscillations along a translation direction of the blade.

7. The device of claim 2, wherein the vibrating means generate oscillations perpendicular to a translation direction of the blade.

8. The device of claim 2, wherein the vibrating means generate oscillations both along a translation direction of the blade and perpendicular to the translation direction of the blade.
